(19) United States
(12) Patent Application Publication
(10) Pub. No.: US 2026/0264397 A1
(43) Pub. Date: Sep. 10, 2026

(54) DEVICE, LIQUID EJECTION HEAD, AND INKJET PRINTER

(71) Applicant: RISO Technologies Corporation, Tokyo (JP)

(72) Inventor: Jun TAKAMURA, Mishima Shizuoka (JP)

(21) Appl. No.: 19/425,991

(22) Filed: Dec. 18, 2025

(30) Foreign Application Priority Data
Mar. 5, 2025 (JP) 2025-034886

(51) Int. Cl. B41J 2/045

(52) U.S. Cl. CPC B41J 2/04588; B41J 2/0452; B41J 2/04541; B41J 2/04573; B41J 2/04581; B41J 2/04596

(57) ABSTRACT

A device for driving an actuator of a liquid ejection head to eject a liquid, includes a first circuit configured to generate one or more base drive waveforms, and a second circuit configured to generate, based on the one or more base drive waveforms, a multi-drop waveform to be input to the actuator to eject one or more drops of the liquid. The multi-drop waveform includes one or more of: a first ejection waveform, a second ejection waveform having lower ejection efficiency than the first ejection waveform, a third ejection waveform that is a part of the first ejection waveform, and a fourth ejection waveform that is a part of the second ejection waveform.

### CROSS-REFERENCE TO RELATED APPLICATION

This application is based upon and claims the benefit of priority from Japanese Patent Application No. 2025-034886, filed on March 5, 2025, the entire contents of which are incorporated herein by reference.

### FIELD

Embodiments described herein relate generally to a device, a liquid ejection head, and an inkjet printer.

### BACKGROUND

An inkjet head mounted in an inkjet printer is known as a liquid ejection device. The inkjet printer ejects ink droplets from the inkjet head to form an image or the like on a surface of a recording medium. The inkjet head ejects ink droplets from a nozzle communicating with a pressure chamber by changing the volume of the pressure chamber with a piezoelectric actuator. The operation of the actuator is controlled by a drive waveform applied to the actuator.

Multi-drop driving is known as one type of ejection controls for an inkjet head. The multi-drop drive waveform is a waveform in which expansion, steady, contraction, and steady operations of the actuator are repeated. Depending on the number of repetitions of the ejection operation, the number of drops can be adjusted and the volume of the droplet can be controlled.

For example, when the ejection waveform for ejecting one droplet is a drop waveform having one positive pulse and one negative pulse, the ejection waveform for ejecting a plurality of drops is a waveform in which this basic drop waveform is repeated according to the number of droplets.

### BRIEF DESCRIPTION OF THE DRAWINGS

FIG. 1 is a diagram showing a liquid ejection device according to a first embodiment.

FIG. 2 is a perspective view showing a liquid ejection head.

FIG. 3 is a cross-sectional view of the liquid ejection head.

FIG. 4 is a diagram showing a drive circuit.

FIG. 5 is a diagram showing drive waveforms.

FIG. 6 is a diagram showing waveforms of a first ejection waveform and a third ejection waveform and vibration analysis results.

FIG. 7 is a diagram showing waveforms of a second ejection waveform and a fourth ejection waveform and vibration analysis results.

FIG. 8 is a diagram showing drive waveforms.

FIG. 9 is a diagram showing drive waveforms according to a comparative example.

FIG. 10 is a diagram showing drive waveforms according to another embodiment.

FIG. 11 is a diagram showing drive waveforms according to another embodiment.

### DETAILED DESCRIPTION

A device, a liquid ejection head, and an inkjet printer capable of performing multi-drop driving with a simple circuit configuration are provided.

In general, according to one embodiment, a device for driving an actuator of a liquid ejection head to eject a liquid, the device comprises: a first circuit configured to generate one or more base drive waveforms; and a second circuit configured to generate, based on the one or more base drive waveforms, a multi-drop waveform to be input to the actuator to eject one or more drops of the liquid. The multi-drop waveform includes one or more of: a first ejection waveform, a second ejection waveform having lower ejection efficiency than the first ejection waveform, a third ejection waveform that is a part of the first ejection waveform, and a fourth ejection waveform that is a part of the second ejection waveform.

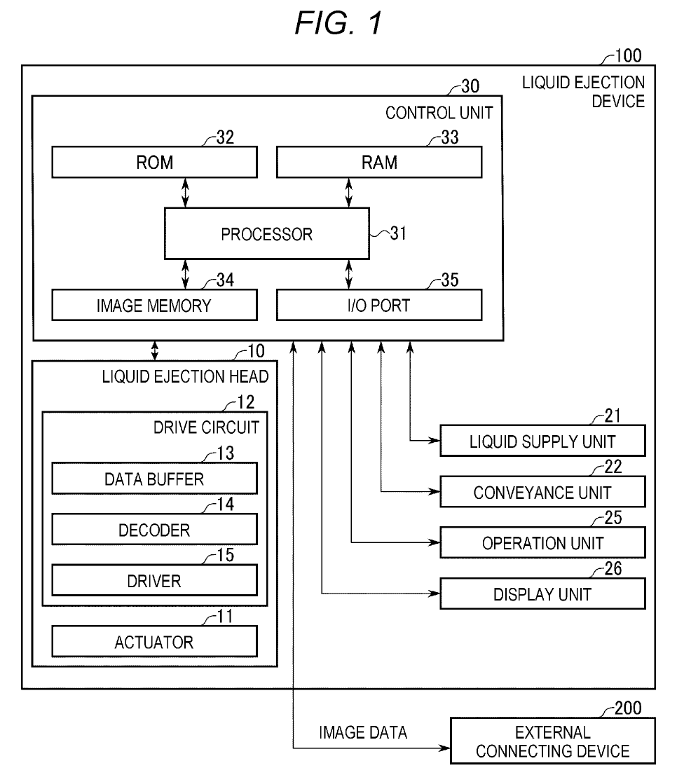

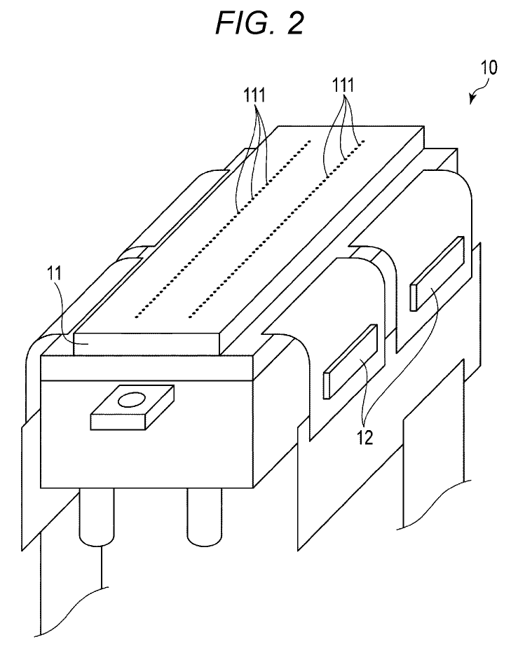

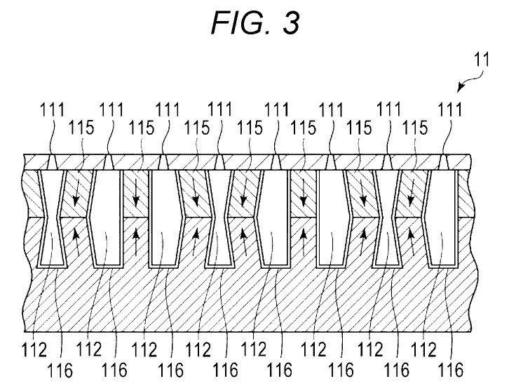

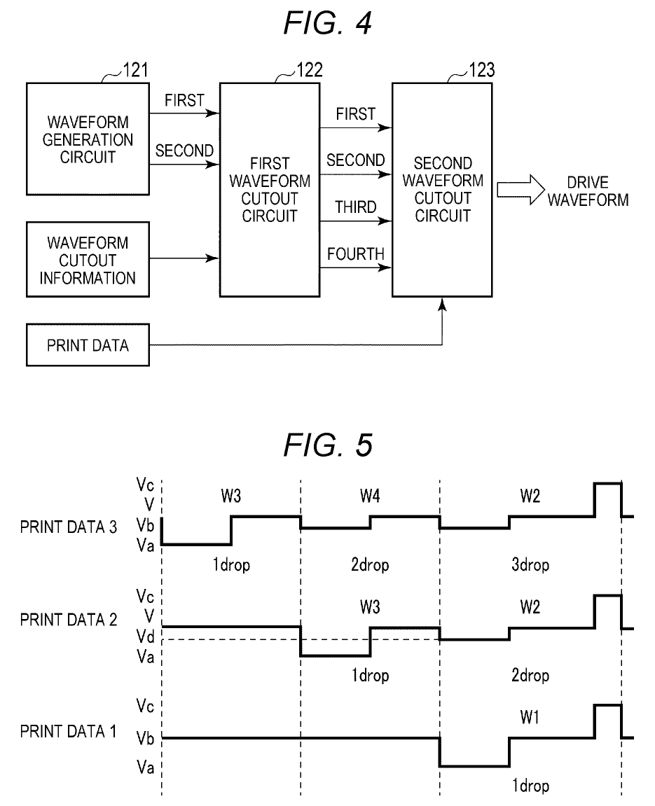

A liquid ejection head 10 and a liquid ejection device 100 according to a first embodiment will be described below with reference to FIGS. 1-8. FIG. 1 is a block diagram showing the liquid ejection device 100 according to the first embodiment. FIG. 2 is a perspective view showing the liquid ejection head 10, and FIG. 3 is a cross-sectional view of an actuator of the liquid ejection head 10. FIG. 4 is a diagram showing a drive circuit. In the drawings, each component is shown enlarged, reduced, or omitted as appropriate for the purpose of description.

As shown in FIG. 1, the liquid ejection device 100 includes the liquid ejection head 10, a liquid supply unit 21, a conveyance unit 22, an operation unit 25, a display unit 26, and a control unit 30.

The liquid ejection device 100 is an inkjet printer that performs image forming processing on a medium such as paper by ejecting a liquid such as ink from the liquid ejection head 10 while conveying the medium such as paper as an ejection target along a predetermined conveyance path passing through a printing position facing the liquid ejection head 10.

The liquid ejection head 10 is, for example, a shear-mode shared-wall type inkjet head. The liquid ejection head 10 may be a non-circulation type head that does not circulate ink or may be a circulation type head that circulates ink. In the present embodiment, the liquid ejection head 10 will be described using the example of the non-circulation type head.

For example, the liquid ejection head 10 includes an actuator 11 including a plurality of piezoelectric elements communicating with nozzles, and a drive circuit 12 (driving device) that drives the actuator 11.

As shown in FIGS. 2 and 3, the liquid ejection head 10 includes, for example, a plurality of nozzles 111 that eject a liquid, a plurality of pressure chambers 112 that communicate with the nozzles, and a flow path including a common chamber communicating with the plurality of pressure chambers 112. The flow path of the liquid ejection head 10 is connected to the liquid supply unit 21, and the liquid is supplied from the liquid supply unit to the flow path of the liquid ejection head 10.

The actuator 11 is, for example, an actuator plate formed of a piezoelectric member in a plate shape and includes a plurality of piezoelectric elements 115 and electrodes 116 formed on the piezoelectric elements 115. For example, groove-shaped pressure chambers 112 are formed between the plurality of piezoelectric elements 115. The actuator 11 applies a voltage to the electrodes 116 of the piezoelectric elements 115 provided corresponding to the pressure chambers 112 to deform the piezoelectric elements 115, so that a pressure is applied to the ink in the pressure chambers 112 to eject the ink from the nozzles.

The drive circuit 12 drives the actuator 11 by applying a drive voltage to electrodes of piezoelectric bodies. The drive circuit 12 generates a control signal and a drive signal for operating the piezoelectric elements 115. For example, the drive circuit 12 generates the control signal for controlling a timing of ejecting a liquid and selection of the piezoelectric element 115 to eject a liquid according to an image signal received from the control unit 30 of the liquid ejection device 100. In addition, the drive circuit 12 generates a voltage to be applied to the electrode 116 of the piezoelectric element 115, that is, a drive signal, according to the control signal. When the drive circuit 12 applies a drive signal to the piezoelectric element 115, the piezoelectric element 115 is driven to change the volume of the pressure chamber 112. That is, the actuator 11 can perform drive control under the control of the control unit 30.

As shown in FIG. 1, the drive circuit 12 includes a data buffer 13, a decoder 14, and a driver 15. The data buffer 13 stores print data in time series for each of the piezoelectric elements of the actuator 11. The decoder 14 controls the driver 15 based on the print data stored in the data buffer 13 for each of the piezoelectric elements. The driver 15 outputs the drive signal for operating the piezoelectric elements 115 based on the control of the decoder 14. The drive signal is, for example, a voltage to be applied to the electrodes 116 of the piezoelectric elements 115.

The liquid supply unit 21 is connected to a primary side of the flow path of the liquid ejection head 10 and supplies the liquid to the flow path of the liquid ejection head 10. For example, the liquid supply unit 21 includes a tank that stores the liquid, a connection flow path that connects the tank and the liquid ejection head 10, and a liquid sending pump that sends the liquid in the tank to the liquid ejection head 10.

The conveyance unit 22 conveys a medium such as paper along a predetermined conveyance path and supplies the medium to a printing position. The conveyance unit 22 includes, for example, a plurality of conveyance rollers and conveyance guides disposed along the conveyance path. The conveyance unit 22 supports the medium such that the medium can be moved relative to the liquid ejection head 10.

The operation unit 25 includes function keys such as a power key, a paper feed key, and an error release key.

The display unit 26 includes a display capable of displaying various states of the liquid ejection device 100.

The control unit 30 is, for example, a control board or circuit, and includes a processor 31, a read only memory (ROM) 32, a random access memory (RAM) 33, an image memory 34, and an I/O port 35 which is an input and output port.

The processor 31 is a processing circuit such as a central processing unit (CPU) which is a controller. The processor 31 controls the units to perform various functions of the liquid ejection device 100 according to an operating system and application programs. For example, the processor 31 controls operations of the liquid ejection head 10, the liquid supply unit 21, and the conveyance unit 22 that are provided in the liquid ejection device 100. During printing, the processor 31 transmits the print data stored in the image memory 34 to the drive circuit 12 in a drawing order.

The ROM 32 corresponds to a read-only main storage portion. The ROM 32 stores the operating system and application programs described above. The ROM 32 may store data necessary for the processor 31 to execute processing for controlling the units.

The RAM 33 corresponds to a rewritable main storage portion. The RAM 33 stores data necessary for the processor 31 to execute processing. The RAM 33 is also used as a work area in which information is appropriately rewritten by the processor 31. The work area may include an image memory in which the print data is loaded.

The image memory 34 stores, for example, the print data from an external connecting device 200.

The I/O port 35 is an interface circuit that receives data from the external connecting device 200 and outputs data to the outside. The print data from the external connecting device 200 is transmitted to the control unit 30 through the I/O port 35 and is stored in the image memory 34.

In the liquid ejection device 100 having such a configuration, the control unit 30 inputs a signal to the liquid ejection head 10 to apply the drive voltage by the drive circuit 12, generates a potential difference between the plurality of piezoelectric elements 115, selectively deforms the piezoelectric elements 115, and increases or decreases the volumes of the pressure chambers 112, thereby ejecting the liquid from the nozzles 111. For example, when the volume of the pressure chamber 112 is expanded or contracted during driving, a pressure vibration occurs in the pressure chamber 112. Due to the pressure vibration, a pressure inside the pressure chamber 112 increases, and droplets are ejected from the nozzles 111 communicating with the pressure chamber 112. For example, according to the signal received from the control unit 30, the drive circuit 12 applies the drive voltage to the electrodes of the piezoelectric elements 115 via the electrodes 116, thereby generating the potential difference between the plurality of piezoelectric elements 115, selectively deforming the piezoelectric elements 115, and changing the volumes of the pressure chambers 112. For example, if the voltage serving as an expansion element is applied, the piezoelectric element 115 is deformed, the volume of the corresponding pressure chamber 112 increases, the pressure decreases, and the liquid in the common chamber flows into the pressure chamber 112. If a drive voltage of a reverse potential is applied to the electrode 116 of the piezoelectric element 115 in a state where the volume of the pressure chamber 112 is increased, the piezoelectric element 115 is deformed to decrease the volume of the pressure chamber 112, and the pressure increases. Therefore, the ink in the pressure chamber 112 is pressurized and ejected from the nozzle 111.

Drive waveforms according to the drive signal generated by the drive circuit 12 of the liquid ejection head 10 will be described with reference to FIGS. 4-8.

For example, as shown in FIG. 4, the drive circuit 12 includes a waveform generation circuit 121, a first waveform cutout circuit 122, and a second waveform cutout circuit 123. The waveform generation circuit 121 generates a first ejection waveform and a second ejection waveform, which are base drive waveforms, and sends the waveforms to the first waveform cutout circuit 122. The first waveform cutout circuit 122 cuts out four types of waveforms of the first ejection waveform, the second ejection waveform, a third ejection waveform, and a fourth ejection waveform based on waveform cutout information and the first ejection waveform and the second ejection waveform which are the base drive waveforms and sends the waveforms to the second waveform cutout circuit 123. The second waveform cutout circuit 123 generates a drive waveform to be input to each actuator based on the four types of waveforms of the first ejection waveform, the second ejection waveform, the third ejection waveform, and the fourth ejection waveform, and the print data.

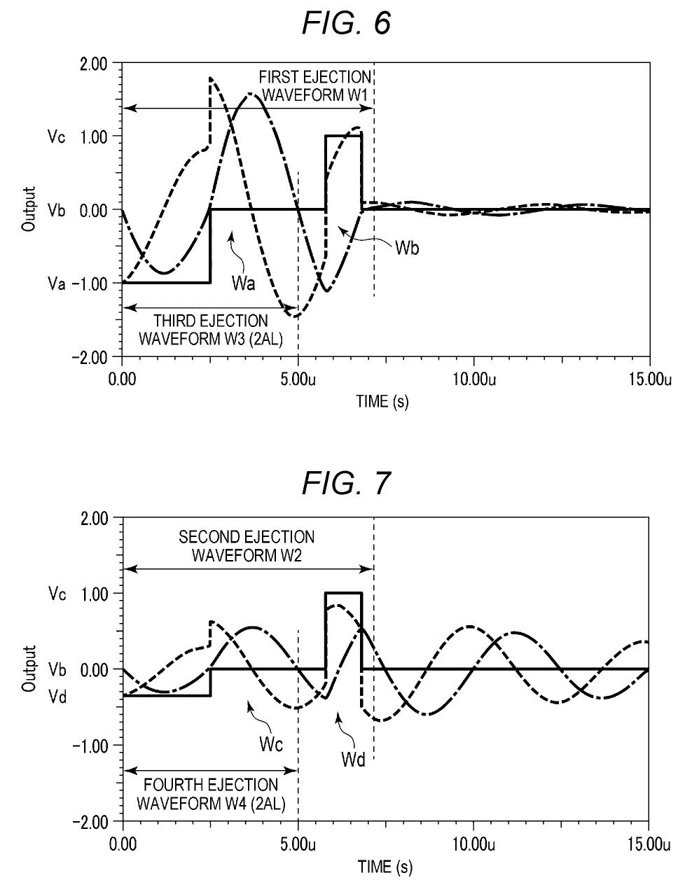

FIG. 5 is a diagram showing drive waveforms during 1-drop ejection, 2-drop ejection, and 3-drop ejection in the drive waveform according to Example 1 of the present embodiment. FIG. 6 is a waveform diagram showing the first ejection waveform and the third ejection waveform, and FIG. 7 is a waveform diagram showing the second ejection waveform and the fourth ejection waveform. In the waveform diagrams, a horizontal axis represents a time, and a vertical axis represents a voltage, an ink flow rate, and an ink pressure. In the drawings, the voltage is indicated by a solid line, a flow rate of a nozzle surface is indicated by a one-dot chain line, and the pressure of the nozzle is indicated by a broken line.

The drive waveform according to the present embodiment is a multi-drop drive waveform for forming one dot by ejecting ink n times (n is an integer of 2 or more) within a drive cycle of one cycle, and is stored in, for example, a memory in the drive circuit 12. An IC of the drive circuit 12 selects which drive waveform to input to the actuator 11 based on tone data sent from the control board.

The drive waveform is a multi-drop waveform in which one pixel includes one or a plurality of n drops (n ≥ 1), and includes any one or more of a plurality of ejection waveforms including the first ejection waveform, the second ejection waveform having lower ejection efficiency than the first ejection waveform, the third ejection waveform formed by a part of the first ejection waveform, and the fourth ejection waveform formed by a part of the second ejection waveform. For example, the example shown in FIG. 5 is a multi-drop waveform of up to three drops. Each drive waveform continuously includes one or more ejection waveforms corresponding to the number of drops.

For example, as shown in FIG. 6, a first ejection waveform W1 includes an ejection waveform portion Wa for ejecting the liquid and a cancel waveform portion Wb for suppressing residual vibration. In the first ejection waveform W1, a voltage is lowered from a first voltage Vb, which is an intermediate voltage, to a second voltage Va, which is lower than the intermediate voltage, and the second voltage Va is returned to the first voltage Vb after continuing the second voltage Va for a first predetermined time. Then, in the waveform, after the first voltage Vb is continued for a second predetermined time, a third voltage Vc higher than the first voltage Vb is applied for a third predetermined time to return to the first voltage Vb. The intermediate voltage of the first ejection waveform is, for example, 0V and is also referred to as a reference voltage.

For example, a width of an expansion pulse of the first ejection waveform W1 is a width of an acoustic length (AL). The AL is a half period of a natural vibration period λ determined by characteristics of the ink and an internal structure of the head.

As an ejection operation by the first ejection waveform W1, when the second voltage Va is applied as an expansion pulse for the first predetermined time, an electric field is generated in a predetermined direction of the piezoelectric element 115, and the piezoelectric element 115 is deformed. The volume of the pressure chamber 112 expands due to the deformation of the piezoelectric element 115, so that an internal ink pressure decreases, and a meniscus of an opening of the nozzle 111 is greatly drawn to a pressure chamber 112 side. Then, vibration of the ink pressure in the pressure chamber 112 (ink chamber) is started, and vibration of the ink flow rate whose phase is shifted by 90 degrees is generated.

When the voltage is returned to the first voltage Vb after the AL time expansion by the expansion pulse, the pressure chamber 112 returns to an original shape. Then, when the first voltage Vb is held for a second predetermined time, the meniscus advances to start ink ejection. Then, after the first voltage Vb is held for the second predetermined time, by further applying the voltage Vc of a contraction pulse for the third predetermined time, the piezoelectric element 115 of the actuator 11 is deformed again, the volume of the pressure chamber 112 is contracted, and the ink pressure is increased, so that the vibration of the pressure and the flow rate in the pressure chamber 112 can be suppressed.

The second ejection waveform W2 is a waveform in which the ejection efficiency is reduced by reducing the drive voltage for the first ejection waveform W1. Similarly to the first ejection waveform W1, the second ejection waveform W2 includes an ejection waveform portion Wc for ejecting the liquid and a cancel waveform portion Wd for reducing the residual vibration. For example, the second ejection waveform W2 is a waveform in which the ejection efficiency is reduced by reducing the drive voltage for the first ejection waveform, and upper and lower widths of the voltage in the expansion pulse and the contraction pulse are small.

For example, as shown in FIG. 7, in the expansion pulse of the second ejection waveform W2, the voltage is lowered from the first voltage Vb which is the intermediate voltage to a fourth voltage Vd which is lower than the intermediate voltage and higher than the second voltage, and the fourth voltage Vd is held for a predetermined time and then returned to the first voltage Vb. Then, after the first voltage Vb is held for a predetermined time, the third voltage Vc higher than the first voltage Vb is applied as the second contraction pulse for a predetermined time, and then the voltage is returned to the first voltage Vb again.

In the present embodiment, in the second ejection waveform W2, the width of the expansion pulse is larger than the width of the contraction pulse, and a duration of the first voltage Vb which is the intermediate voltage is larger than the width of the expansion pulse.

As shown in FIG. 6, the third ejection waveform W3 is a waveform cut out from the first ejection waveform W1 and includes the ejection waveform portion Wa. That is, the third ejection waveform W3 is a portion of the first ejection waveform W1 excluding the cancel waveform portion Wb and corresponds to a waveform having a time width before the cancel waveform portion Wb. For example, a drive cycle of the third ejection waveform W3 is 2AL.

As shown in FIG. 7, the fourth ejection waveform W4 is a waveform cut out from the second ejection waveform W2 and includes the ejection waveform portion Wc. That is, the fourth ejection waveform W4 is a portion of the second ejection waveform W2 excluding the cancel waveform portion Wd, and corresponds to a waveform having a time width before the cancel waveform portion Wd. For example, a drive cycle of the fourth ejection waveform is 2AL.

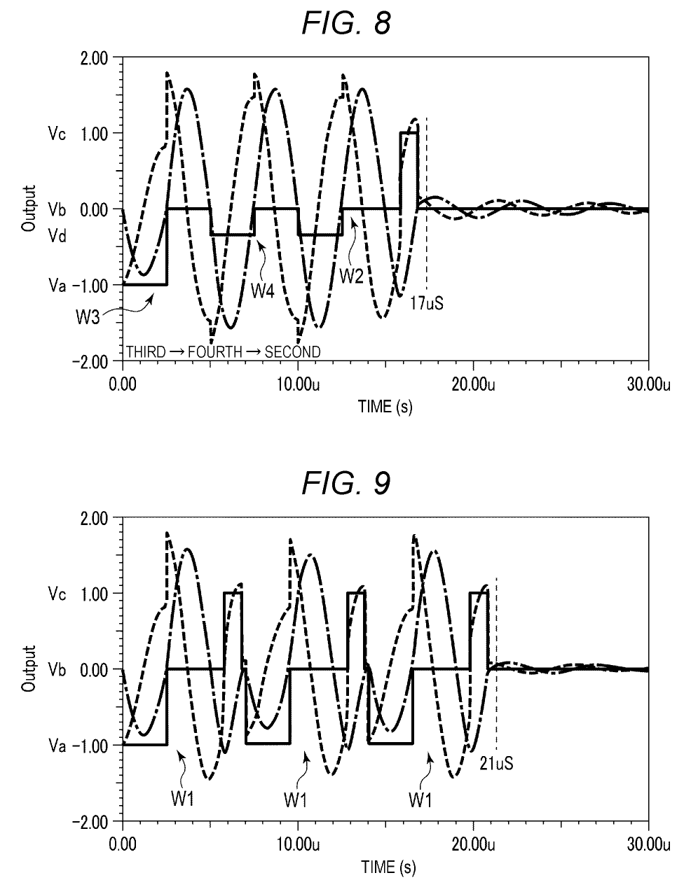

FIGS. 5 and 8 show examples of the drive waveforms according to the present embodiment. In the present embodiment, when ejecting a plurality of drops, the drive circuit 12 ejects a first drop using the third ejection waveform W3 and ejects a second drop with the fourth ejection waveform W4 or the second ejection waveform W2. On the other hand, when ejecting only one drop, the ejection is performed with the first ejection waveform W1.

Print data 1 corresponds to a drive waveform for ejecting one drop. The print data 1 includes the first ejection waveform W1.

Print data 2 is a drive waveform for ejecting two drops. The waveform of the print data 2 includes the third ejection waveform W3 for ejecting the first drop and the second ejection waveform W2 for ejecting the second drop.

Print data 3 is a drive waveform for ejecting three drops. The waveform of the print data 3 includes the third ejection waveform W3 for ejecting the first drop, the fourth ejection waveform W4 for ejecting the second drop, and the second ejection waveform W2 for ejecting the third drop.

FIG. 9 is a diagram showing drive waveforms and vibration analysis results according to Comparative Example 1. The waveform according to Comparative Example 1 is a waveform in which the first ejection waveform in FIG. 5 is repeated three times.

According to the liquid ejection head 10 in the present embodiment, ejection performance can be improved by combining different ejection waveforms, and the circuit configuration can be simplified by cutting out apart from the base drive waveform. That is, as the drive waveform, four different types of waveforms can be generated by a generation circuit of the first ejection waveform and the second ejection waveform and a cutout circuit that cuts out the waveforms in a time direction. For example, when there are n types of second ejection waveforms, (n + 1) × 2 types of waveforms can be generated. By combining a plurality of types of waveforms, it is possible to more finely control adjustment of an ejection speed for two or more drops.

According to the example of the embodiment described above, by reducing the ejection efficiency of the fourth ejection waveform W4, it is possible to reduce an increase in the pressure and the flow rate during the 2AL drive and to implement stable ejection.

For example, when the third ejection waveform is repeated, there is a possibility that power is too strong and omission occurs, but it is possible to secure print quality by setting the second and third drops to the waveform in which the ejection efficiency is reduced.

According to the example of the embodiment described above, it is possible to increase a speed at the time of multi-drop, and it is possible to change a drive frequency according to a maximum number of drops. For example, as in Comparative Example, when driving is performed with the first ejection waveform in which the ejection efficiency is not reduced, amplification of the pressure and the flow rate becomes too large, and the stable ejection cannot be performed. However, according to the present embodiment, by combining a plurality of types of waveforms including the second ejection waveform and the fourth ejection waveform in which the ejection efficiency is reduced, it is possible to more finely control the adjustment of the ejection speed for two or more drops.

Embodiments of this disclosure are not limited to the above-described configuration.

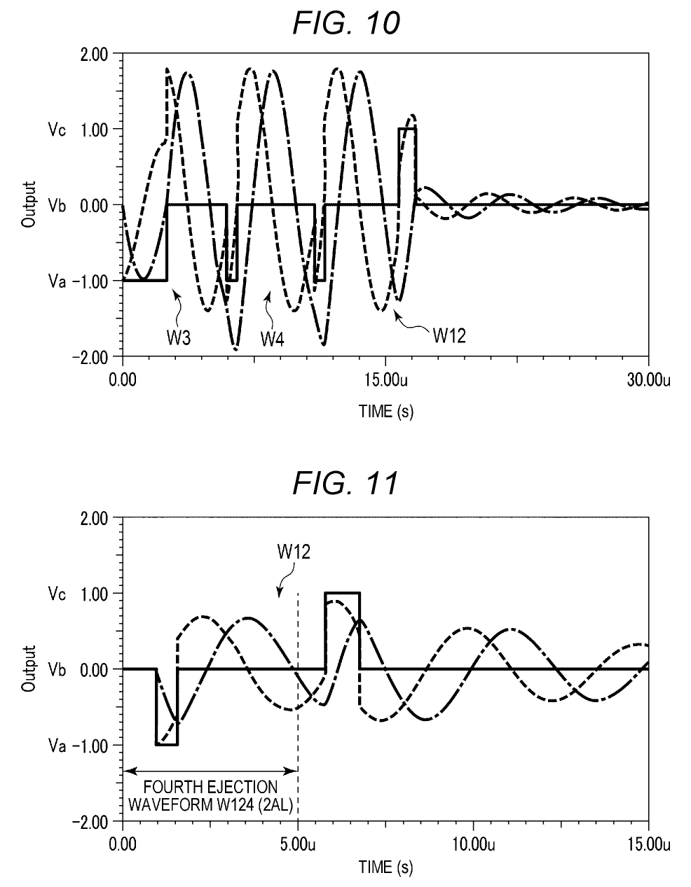

In the embodiment described above, the second ejection waveform W2 is a waveform in which the ejection efficiency is reduced by reducing the drive voltage, but the disclosure is not limited thereto. For example, as shown in FIGS. 10 and 11, a second ejection waveform W12 may be a waveform in which the ejection efficiency is reduced by shortening an expansion time of the first ejection waveform W1. FIG. 11 is a waveform diagram of the second ejection waveform W12 according to the present embodiment. FIG. 10 is a drive waveform diagram at the time of 3-drop ejection and is a drive waveform in which the third ejection waveform W3, a fourth ejection waveform W124, and the second ejection waveform W12 are sequentially applied. In the second ejection waveform W12, the expansion pulse lowers the voltage from the first voltage Vb, which is the intermediate voltage, to the second voltage Va lower than the intermediate voltage, holds the second voltage Va for a fourth predetermined time, and then returns the second voltage Va to the first voltage Vb. The fourth predetermined time is shorter than the first predetermined time.

In the configuration in which the ejection efficiency is reduced by the drive duration as described above, similarly to the first embodiment described above, the ejection performance can be improved by combining different ejection waveforms, and the drive circuit can be simplified by cutting out a part from the base drive waveform.

For example, in the embodiment described above, the drive waveform for ejecting the maximum of three drops is described, but the disclosure is not limited thereto. The drive waveform may be, for example, a drive waveform for ejecting four or more drops.

The example in which four types of ejection waveforms are formed from two types of base drive waveforms is described, but the disclosure is not limited thereto. Different waveforms may be generated by cutting out a part based on three or more ejection waveforms.

As a modification, for example, it is also possible to use the first ejection waveform W1 or the third ejection waveform W3 at the time of multi-drop ejection. For example, when the ink cannot be ejected using the second ejection waveform W2, such as when a viscosity of the ink is high, a final drop can be ejected using the first ejection waveform W1. That is, in this case, it is also possible to apply and drive the third ejection waveform W3, the third ejection waveform W3, and the first ejection waveform W1 in this order at the time of 3-drop ejection, and it is possible to select an appropriate combination according to the viscosity and physical properties of the ink. For example, since the ejection efficiency is required for the first drop, the first ejection waveform W1 or the third ejection waveform W3 may be used, and any of the first ejection waveform W1, the second ejection waveform W2, the third ejection waveform W3, and the fourth ejection waveform W4 may be used thereafter. In these cases, the drive frequency can also be adjusted according to the maximum number of drops. In these embodiments, since the plurality of ejection waveforms to be selected are divided into short units, the time can also be adjusted. For example, in the case of print data that may be thin, the maximum drop can be reduced, and the printing speed can be increased accordingly.

A voltage value applied to the piezoelectric elements 115 can be appropriately adjusted according to various conditions. For example, a potential difference may be generated by grounding one of adjacent piezoelectric elements 115 and applying a voltage to the other piezoelectric element 115, or a potential difference may be generated by applying voltages to both of the adjacent piezoelectric elements 115.

For example, the configuration of the liquid ejection head 10 is not limited to the example described above, and may be used in a head of another type. For example, the liquid ejection head may drive a liquid ejection unit by causing vibration of a vibration plate provided between the pressure chamber 112 and a drive element unit by deforming the drive element unit.

Potentials of the drive waveform can be appropriately changed, and a voltage value applied to the piezoelectric elements 115 can be appropriately adjusted according to various conditions. For example, a potential difference may be generated by grounding one of adjacent piezoelectric elements 115 and applying a voltage to the other piezoelectric element 115, or a potential difference may be generated by applying voltages to both of the adjacent piezoelectric elements 115.

The drive waveform is not limited to a pull-shooting waveform, but may be a push-shooting waveform or a push-pull-shooting waveform.

For example, the configuration of the liquid ejection head 10 is not limited to the example described above, and may be used in a head of another type. For example, a structure in which the ink is ejected by electrostatically deforming a diaphragm, or a heating element type structure in which the ink is ejected from a nozzle using thermal energy of a heater or the like may be employed. In these cases, the diaphragm or the heater serves as an actuator for applying the pressure vibration to the inside of the pressure chamber 112.

The liquid ejection device 100 is an inkjet printer that forms a two-dimensional image with ink on an image forming medium, which is exemplified, but the disclosure is not limited thereto. For example, the liquid ejection device 100 may be a 3D printer, an industrial manufacturing machine, or a medical machine. The liquid ejection device may be the 3D printer, the industrial manufacturing machine, the medical machine, or the like, and may form a three-dimensional object by ejecting, for example, a material substance or a binder for solidifying the material from an inkjet head.

According to at least one of the embodiments described above, it is possible to provide a liquid ejection head driving device capable of performing multi-drop driving with a simple circuit configuration.

While certain embodiments have been described, these embodiments have been presented by way of examples only, and are not intended to limit the scope of the disclosure. These novel embodiments can be implemented in various other forms, and various omissions, substitutions, and modifications can be made without departing from the gist of the disclosure. The accompanying embodiments and their equivalents are intended to cover such forms or modifications as would fall within the scope and spirit of the disclosure.

What is claimed is:

1. A device for driving an actuator of a liquid ejection head to eject a liquid, the device comprising:
a first circuit configured to generate one or more base drive waveforms; and
a second circuit configured to generate, based on the one or more base drive waveforms, a multi-drop waveform to be input to the actuator to eject one or more drops of the liquid, wherein
the multi-drop waveform includes one or more of:
a first ejection waveform,
a second ejection waveform having lower ejection efficiency than the first ejection waveform,
a third ejection waveform that is a part of the first ejection waveform, and
a fourth ejection waveform that is a part of the second ejection waveform.

2. The device according to claim 1, wherein
each of the first and second ejection waveforms includes an ejection waveform portion by which the liquid is ejected and a cancel waveform portion by which residual vibration is suppressed.

3. The device according to claim 2, wherein
each of the third and fourth ejection waveforms includes an ejection waveform portion by which the liquid is ejected.

4. The device according to claim 3, wherein
when ejecting a plurality of drops, a first drop is ejected using the third ejection waveform and a second drop is ejected using the fourth ejection waveform or the second ejection waveform.

5. The device according to claim 1, wherein
a magnitude of an expansion pulse voltage of the second ejection waveform is less than a magnitude of an expansion pulse voltage of the first ejection waveform.

6. The device according to claim 5, wherein
a magnitude of an expansion pulse voltage of the fourth ejection waveform is less than a magnitude of an expansion pulse voltage of the third ejection waveform.

7. The device according to claim 1, wherein
a duration of the second ejection waveform is shorter than a duration of the first ejection waveform.

8. The device according to claim 1, wherein
a duration of the third ejection waveform is shorter than a duration of the first ejection waveform.

9. The device according to claim 1, wherein
drive cycles of the third ejection waveform and the fourth ejection waveform are 2 acoustic lengths (AL).

10. The device according to claim 1, wherein
when ejecting only one drop, the multi-drop waveform consists of the first ejection waveform.

11. The device according to claim 1, wherein
when ejecting two drops, the multi-drop waveform includes the third ejection waveform followed by the second ejection waveform.

12. The device according to claim 1, wherein
when ejecting three drops, the multi-drop waveform includes the third ejection waveform, followed by the fourth ejection waveform, followed by the second ejection waveform.

13. The device according to claim 1, wherein
a duration of an expansion pulse of the second ejection waveform is shorter than a duration of an expansion pulse of the first ejection waveform.

14. The device according to claim 1, wherein
the first ejection waveform includes an expansion pulse having a pulse width of AL.

15. The device according to claim 1, wherein
the first ejection waveform applies a voltage lower than an intermediate voltage and another voltage higher than the intermediate voltage.

16. A liquid ejection head comprising:
an actuator configured to eject a liquid;
a first circuit configured to generate one or more base drive waveforms; and
a second circuit configured to generate, based on the one or more base drive waveforms, a multi-drop waveform to be input to the actuator to eject one or more drops of the liquid, wherein
the multi-drop waveform includes one or more of:
a first ejection waveform,
a second ejection waveform having lower ejection efficiency than the first ejection waveform,
a third ejection waveform that is a part of the first ejection waveform, and
a fourth ejection waveform that is a part of the second ejection waveform.

17. The liquid ejection head according to claim 16, wherein
each of the first and second ejection waveforms includes an ejection waveform portion by which the liquid is ejected and a cancel waveform portion by which residual vibration is suppressed.

18. The liquid ejection head according to claim 17, wherein
each of the third and fourth ejection waveforms includes an ejection waveform portion by which the liquid is ejected.

19. The liquid ejection head according to claim 18, wherein
when ejecting a plurality of drops, a first drop is ejected using the third ejection waveform and a second drop is ejected using the fourth ejection waveform or the second ejection waveform.

20. An inkjet printer comprising:
a liquid ejection head configured to eject ink; and
a processor configured to control the liquid ejection head, wherein
the liquid ejection head includes:
an actuator configured to eject the ink,
a first circuit configured to generate one or more base drive waveforms, and
a second circuit configured to generate, based on the one or more base drive waveforms, a multi-drop waveform to be input to the actuator to eject one or more drops of the ink, wherein
the multi-drop waveform includes one or more of:
a first ejection waveform,
a second ejection waveform having lower ejection efficiency than the first ejection waveform,
a third ejection waveform that is a part of the first ejection waveform, and
a fourth ejection waveform that is a part of the second ejection waveform.
